(19) United States
(12) Patent Application Publication
(10) Pub. No.: US 2019/0304317 A1
(43) Pub. Date: Oct. 3, 2019

(54) EDUCATION SYSTEM AND BOOK DESIGN TO IMPLEMENT THE EDUCATION SYSTEM

(71) Applicant: SEMS TURIZM KAY. TEKS.GUV. TEM. INS. TAR. HAYV. IC VE DIS TICARET LTD. STI., SIVAS (TR)

(72) Inventors: Mehmet KARATEPE, SIVAS (TR); Reyhan KARATEPE, SIVAS (TR)

(73) Assignee: SEMS TURIZM KAY. TEKS.GUV. TEM. INS. TAR. HAYV. IC VE DIS TICARET LTD. STI., SIVAS (TR)

(21) Appl. No.: 16/004,504

(22) Filed: Jun. 11, 2018

(30) Foreign Application Priority Data
Mar. 30, 2018 (TR) 2018/04489

(51) Int. Cl. G09B 1/16

(52) U.S. Cl. CPC G09B 1/16

(57) ABSTRACT

A book by which the education system according to the present invention is applied includes at least one book cover, at least two book pages between the book cover, at least one lace combining the book cover and the book pages, and figures positioned on the book pages.

### CROSS REFERENCE TO THE RELATED APPLICATIONS

This application is based on and claims priority from the Turkish Patent Application No. 2018/04489, filed on Mar. 30, 2018, the entire contents of which are incorporated herein by reference.

### TECHNICAL FIELD

The present invention relates to a novel education system and a book design by which this system is implemented for use in early age education, particularly for preschool education. The present invention particularly relates to a book design made of a nonwoven fabric with a felt-like surface, facilitating an education system based on “learning-by-doing” and the application of this system.

### BACKGROUND

The importance of education both for individual and social success and welfare is now a generally accepted fact. Education, as a fact, comprises any stages from the birth to the death of an individual. Within the conventional education system, i.e. the school education, hundreds of methods and tools are being used for the preschool education and for continuing education which starts with the working life. It is a known fact that the education methods and tools developed particularly for preschool education and used during this period influences the following life periods, i.e. the school life and the postschool daily or social life. Within this context, the preschool education is given particular importance.

Tens of education methods and tools are being used for preschool education. Some of them relate to revealing the talents of children, some of them to developing their foreign languages and some to developing their morals and human relations. Beside these, there are naturally further education methods and tools for other necessities of children. One of the methods and means becoming prominent within this context is “learning-by-doing”, or in original English words, the “Maker Movement”. The most important feature of this method is that it allows the children to touch the things by hands they are learning and to use education tools to make different things. Thus, children both learn better and add something from themselves on the things they learn so that their creativity is also positively supported.

One of the education means from the prior art in relation to children education is the so-called jigsaw puzzles. These toys allow the children to disassemble and reassemble themselves and thus contribute to their understanding how they are.

One of the education means used according to the prior art is the audio picture books. Such books comprise colorful illustrations which the children may like and electronic audio devices by which tales are told. Even though these books are useful, they are more entertaining than being educational.

One of the education means used according to the prior art is books comprising three-dimensional images. When the books are closed, these images assume a folded state like a normal page, but when the books are opened they are erected and form three-dimensional images. Thus, the children are enabled to see and understand one object, which may be a tree, a fruit, a house, etc. three-dimensionally.

One of the education means used according to the prior art is described in the U.S. patent U.S. Pat. No. 6,210,172. A storytelling book is described in that patent document to improve the imagination of children using images. That patent document basically describes a book comprising selected headings and images.

Another education means used according to the prior art is described in the European patent EP1799466. In that patent document is described a book and a world-shaped rotating spherical part located in a central part of the book. The basic feature of this book is to help children learn the world geography.

A further education means used according to the prior art is described in the European patent U.S. Pat. No. 5,989,033. In that patent document is described a type of book like a coloring book, comprising pictures to be colored.

A further education means used according to the prior art is described in the European patent U.S. Pat. No. 6,089,943. In that patent document is comprised pictures of some objects, the names and letters of these pictures, and some barcodes representing what these pictures are. With that book, which seems to be designed for developing the preschool or primary school children's abilities of recognizing drawings, knowing and spelling the names thereof, audio narrations of respective objects are heard when the barcode sings are read by means of a barcode reader.

A further education means used according to the prior art is described in the European patent U.S. Pat. No. 9,656,183. In that patent document is described a book in which three-dimensional figures are presented between the pages when the book is opened.

A further education means used according to the prior art is described in the U.S. patent US2013/0078602. In that patent document, miniaturized figures are presented of clothing items like buttons, pocket, etc. to teach children how to manipulate the items. Even if that patent document is very close to the education system according to the present invention, it is considered that the education system according to the present invention is more flexible, and the materials used and the construction/composition thereof are different, as will be described below.

### SUMMARY

The education system according to the present invention and a book design by which this system is implemented provides a book-like product, made of nonwoven textile materials, and capable to provide an education content with almost infinite options so that the imagination of educators and educated children are not restricted. The book-like product provides an opportunity by which any kind of objects, vegetables, fruits, plants, animals, economical and engineering mechanisms etc. can be described and changed in an unlimited manner. This opportunity is realized using designs of book pages made of nonwoven materials preferably having a felt-like surface and Velcro connections providing the fixation or positioning of figures, which may be made of the same or different materials, onto the nonwoven pages. A Velcro type connection is made of two pieces, one having a vast number of flexible mini hooks and the other a vast number of flexible mini rings, and is generally used in clothing, footwear and many other items to be connected to each other or to other items. In the system according to the present invention, the term “book like” refers not exactly to a book, but rather to a feature that can be changed and modeled depending on the imagination of the educator and educated children.

The basic feature of the education system according to the present invention is that the children are not provided only with narration of an educational content, but also are enabled to see and touch it so that the contents can be kept in mind better.

Another feature and advantage of the education system according to the present invention is that it is flexible so that limitless examples can be provided in any kind of information field, e.g. related to the daily life or nature, and similarly in the fields of economy, engineering, etc. This flexibility eliminates the obligation to teach/learn the content of an education book or similar object according to the present invention, for instance.

The book by which the present education system is implemented is not harmful for children and does not contain any harmful materials, and based on its light-weighing and soft texture, it is conveniently used by children. When necessary, its nonwoven textile can be impregnated with antibacterial substances during production or afterwards, and can be made completely harmless and antibacterial.

In a book in which the education system according to the present invention is applied, only the pages are kept stationary, but the educational content, e.g. figures or miniaturized examples (miniaturized models) of objects, materials, plants, animals or any scientific field such as economy can be changed in an almost unlimited manner. Thus, both the education contents are shown to children in a one-to-one fashion in a tangible manner, and the children are allowed to make new objects using their own imagination. By virtue of this feature and contrary to what is known in the prior art as “puzzles”, which can be defined as objects that can “disassembled and then assembled back”, the present invention provides an approach by which the basic concept is “to learn and to shape anything that you can imagine boundlessly.” This approach allows a children to develop and use his/her imagination to a point which is beyond what puzzles provide with limited sets to be disassembled and gathered back.

In order to provide a better understanding of the book which is the basic component of the education system according to the present invention, it shall be referred to the figures briefly described hereunder.

### BRIEF DESCRIPTION OF THE DRAWINGS

FIG. 1 is a perspective view of a book used in the education system according to the present invention.

FIG. 2 is a plan view of the book used in the education system according to the present invention.

FIG. 3 is a side view of the book used in the education system according to the present invention.

FIG. 4 is a perspective view of the book used in the education system according to the present invention, wherein some pages are partially opened.

FIG. 5 is a view wherein an apple and a worm thereon are representatively shown in a page of the book used in the education system according to the present invention.

FIG. 6 is a view wherein a tree and fruits thereon are representatively shown in a page of the book used in the education system according to the present invention.

FIG. 7 is a view wherein the parts of a car are representatively shown in a page of the book used in the education system according to the present invention.

FIG. 8 is a view wherein a street, cars, and traffic lights are representatively shown from above in a page of the book used in the education system according to the present invention.

FIG. 9 is a view wherein a financial system and the logic of saving money are representatively illustrated in a page of the book used in the education system according to the present invention.

FIG. 10 is a view wherein a clothing is representatively shown in a page of the book used in the education system according to the present invention.

FIG. 11 is a side cross-sectional view of a single-piece nonwoven page and a figure thereon in the book used in the education system according to the present invention.

FIG. 12 is an enlarged detailed section of a side cross-sectional view of a single-piece nonwoven page and a figure thereon in the book used in the education system according to the present invention.

FIG. 13 is a side cross-sectional view of a nonwoven page with a reinforced interior and a figure thereon in the book used in the education system according to the present invention.

FIG. 14 is an enlarged detailed section of a side cross-sectional view of a nonwoven page with a reinforced interior and a figure thereon in the book used in the education system according to the present invention.

### REFERENCE NUMBERS OF PARTS AND SECTIONS IN FIGURES ILLUSTRATING THE PRESENT INVENTION

1—Book
2—Book cover
   2a—Title
   2b—Cover picture
3—Book pages
   3a—Page surface
   3b—Page support
   3c—Layered page
4—Laces
5—Figures
   5a—Velcro connection
   5b—Figure surface
   5c—Small figure
6—Money
7—Wallet
8—Miniature clothing
9—Zipper

### DETAILED DESCRIPTION

The education system according to the present invention and a book by which the education system is implemented is basically made of a nonwoven fabric material, named also as felt in the market and comprising complex structure of gaps and intertwined fibers on the surface. Figures with a Velcro-type surface having tiny hooks are fastened or attached to the surface in a temporary manner. The nonwoven fabric material can either be designed as a normal book, or in many different designs. However, book-like illustrations will be used here in the figures to make the present technique easily understandable.

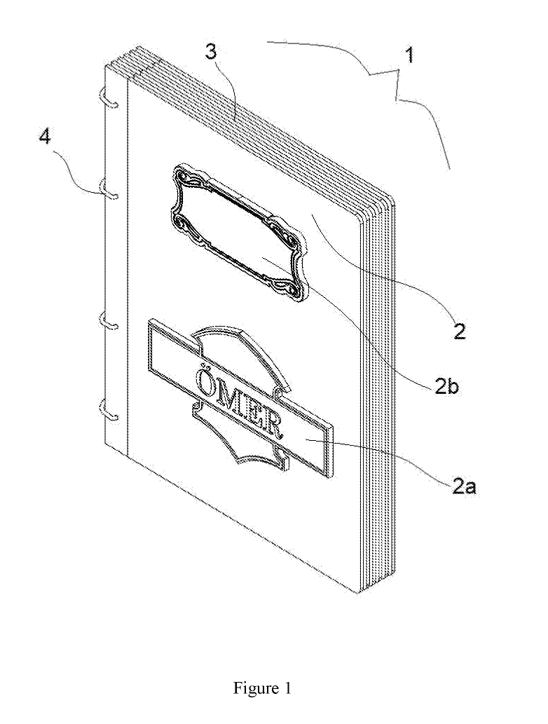

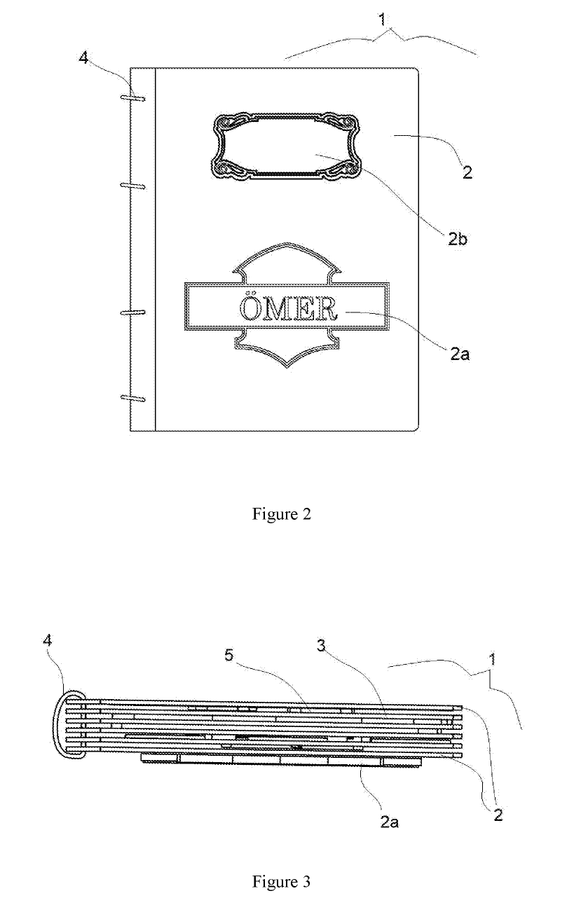

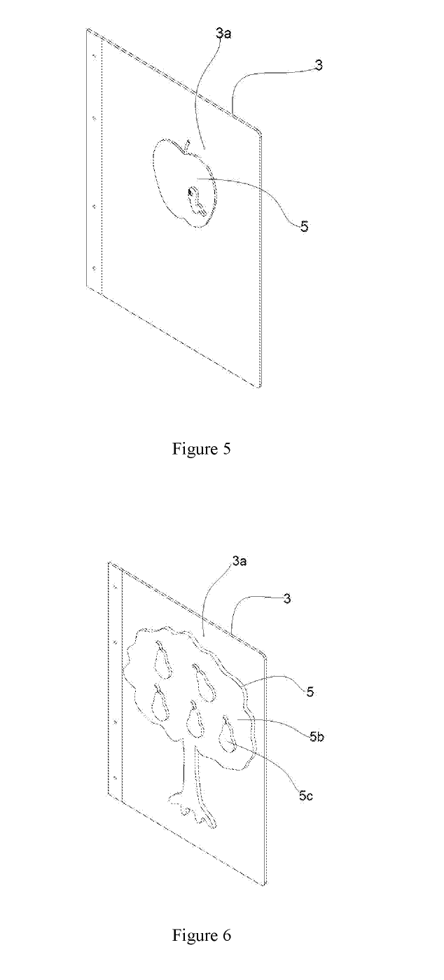

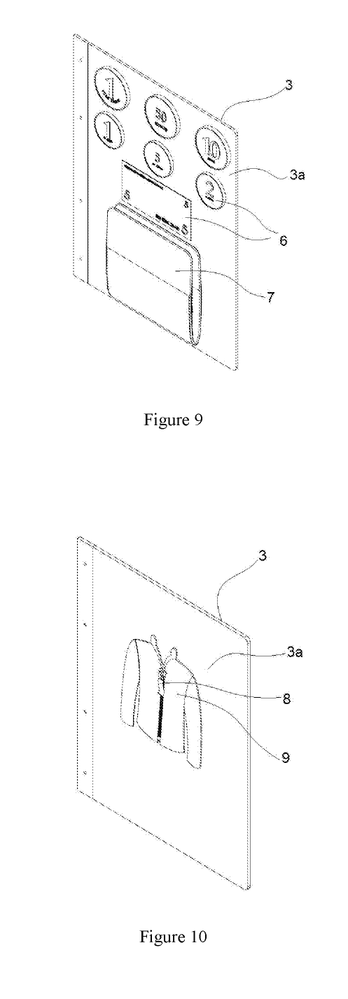

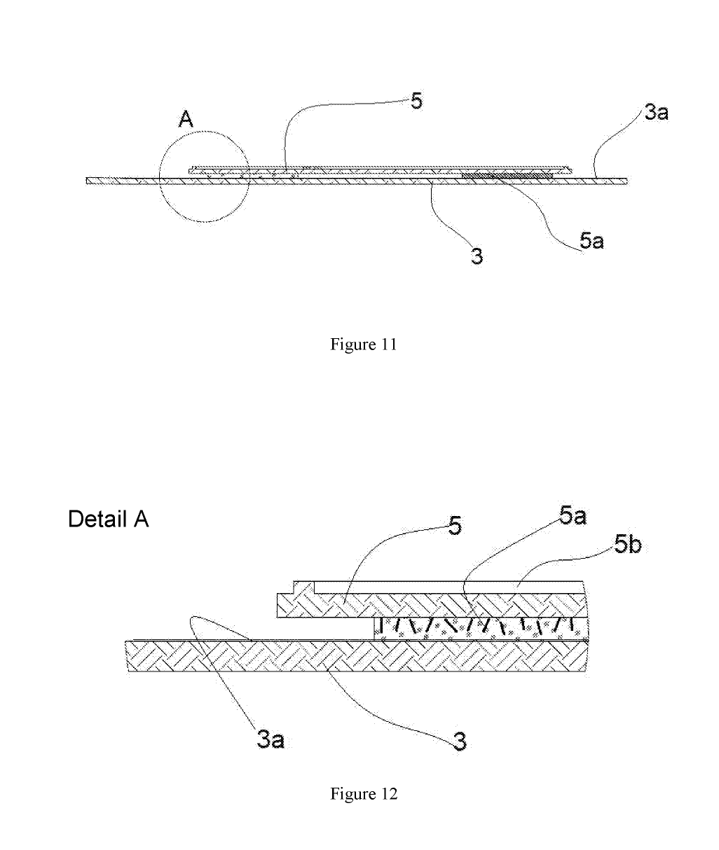

A book for use in the education system according to the present invention is generally illustrated in FIGS. 1, 2, 3 and 4. The form of the pages and of the figures provided thereon are illustrated in FIGS. 5, 6, 7, 8, 9 and 10. The structure of the book pages and the positioning of the figures thereon, in turn, are illustrated in FIGS. 11, 12, 13 and 14 in cross-sectional views.

The education system according to the present invention is basically designed to teach the children, particularly the preschool children anything, such as the nature, animals, humans, machines, economy, etc. Here, the basic difference from the prior art is that any figure representing anything can be replaced in the present invention with another one and fasten it temporarily on a book-like product, and make any changes thereon. According to the prior art, three-dimensional stationary representations or figures were integrated into the books used for these purposes. Here, this can be easily achieved using the educational book according to the present invention. For this purpose, a book-like product is designed and figures are provided which can be attached to the pages of the book. The most convenient material for this purpose is a nonwoven fabric with a felt-like structure and figures provided with Velcro-type connection means. The structure particularly of the surface of the nonwoven fabric comprises a mesh of fibers or filaments in a complex form. These filaments are artificial or natural fibers. These fibers are blended in production systems of nonwoven materials and are nested and fused together in machines such as needling machines. In result, a structure is obtained which is composed of intertwined filaments which are not woven. In order to fasten anything on this structure, a Velcro-type connection is formed, which comprises tiny hooks on its surface. By virtue of this connection, the figures are positioned on the pages of the present book in any desired fashion and their positions are changed as desired.

The book (1) by which the education system according to the present invention is applied comprises at least two book pages (3), a page surface (3a) on the book page (3), on which surface soft and complex intertwined nonwoven filaments are formed, and FIG. 5) positioned on said book surface (3a) by means of Velcro-type connectors (5a) provided on themselves.

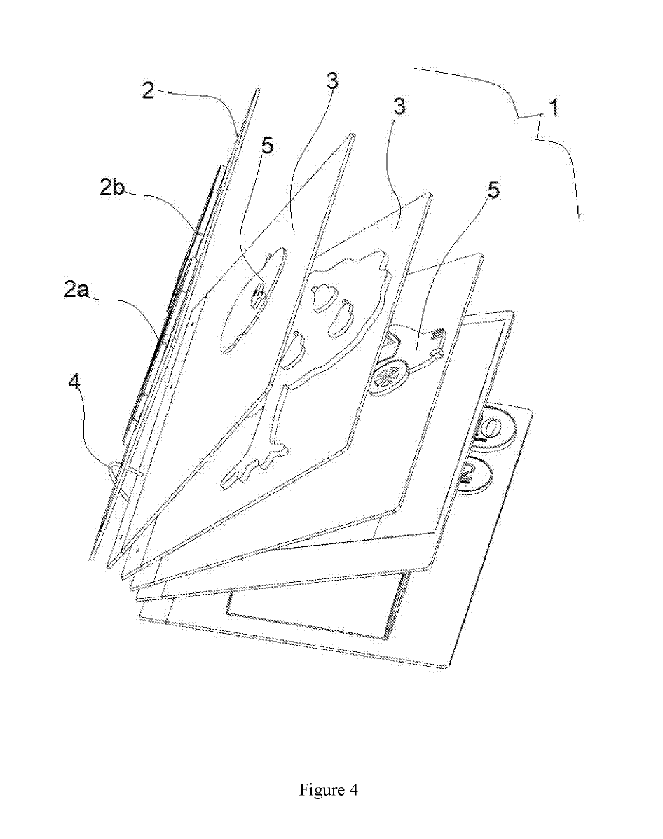

Particularly as illustrated in FIG. 4, the book (1) by which the education system according to the present invention is applied comprises at least one book cover (2), at least two book pages (3) between said book cover (2), at least one lace (4) combining said book cover (2) and the book pages (3), and FIG. 5) positioned on said book pages (3). Here, in order to provide the book (1) with a real book appearance, a book cover (2) and a title (2a) and cover illustrations (2b) are provided. This, however, is optional. Again here, the book cover (2) and book pages (3) are combined using laces (4) to provide a book form. Here the laces (4) can be in the form of threads or ribbons, or other materials or techniques such as book binding, wire connection, stapling or other forms can also be used for the same purpose.

As can be seen in the illustration in FIG. 5, the book page (3) of the book (1) by which the education system according to the present invention is applied comprises a page surface (3a) made of filaments intertwined in a complex fashion with gaps felt between the filaments. The page surface (3a) is like the surface of standard nonwoven or felt-like materials. The lower surface of FIG. 5) are provided with Velcro-type connection means (5a) and are attached to the page surface using these connection means. In order to detach the figures, a small force is exerted by a human finger. The amount of the force should naturally be low enough so that a child can detach or remove the figures from the page surface to change or replace the figures. Here, the FIG. 5) can be made similarly from a nonwoven material or another material. However, the surface of the FIG. 5) should also be a nonwoven surface (5b) so that other smaller FIG. 5c) can be fastened thereto using tiny hooks (5a) of Velcro type as illustrated in FIG. 5 for the worm on the apple or as illustrated in FIG. 6 for the fruits on the tree. Normally, the book pages (3) and the the surface (3a) of the pages are made of nonwoven materials. Any FIG. 5) to be taught can be positioned on said book surface (3a).

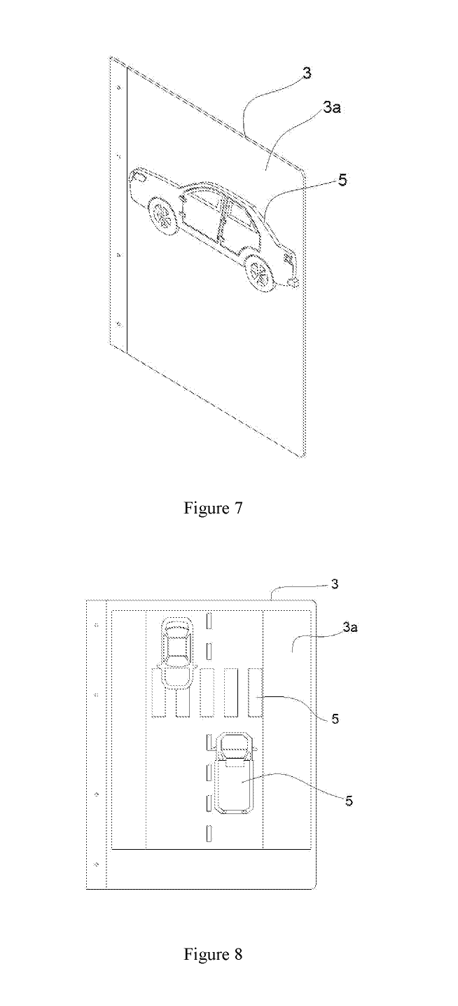

Under normal conditions, the FIG. 5) comprise on their lower side hook-type connection means (5a), and on their upper side an optional figure surface (5b) which may be again made of a nonwoven material. Small FIG. 5c) are positioned on said figure surface (5b). The FIG. 5) can be of any shape or material. They may be a car as illustrated in FIG. 7, components of a traffic system as illustrated in FIG. 8, money (6) and a wallet (7) for teaching economy and finance system as illustrated in FIG. 7, and a clothing (8) and zipper (9) for a miniature clothing as illustrated in FIG. 10. Various other shapes can be provided. Using various figures in different shapes, a child can be taught so that he/she sees and touches what he/she is learning. On the other hand, the children can have fun and at the same time compose different educational combinations under adult supervision. As can be seen, this system is entirely based on “learning by practicing and creating.”

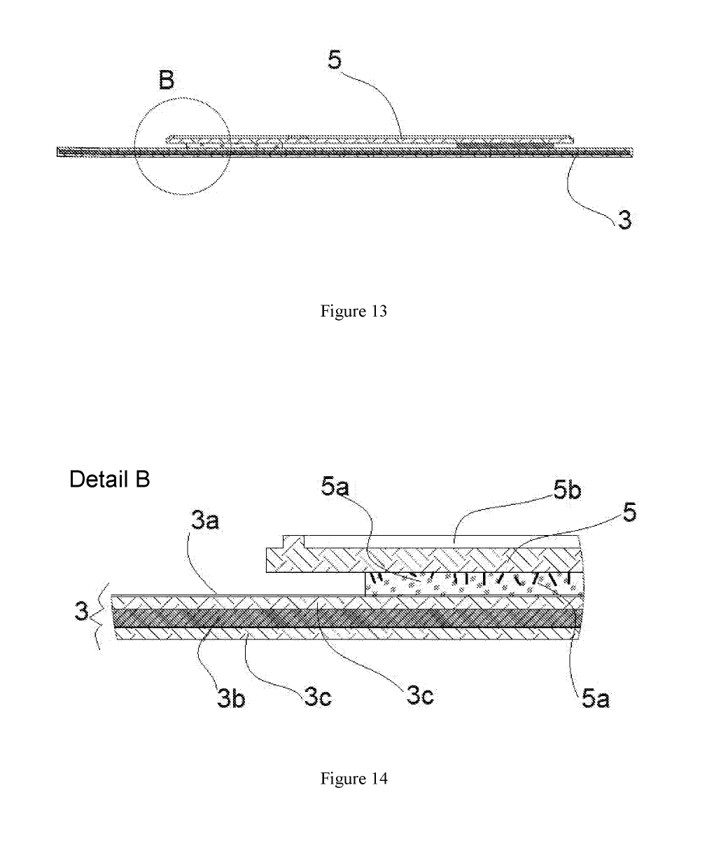

The book (1) used within the education system according to the present invention is composed of nonwoven book pages (3) and FIG. 5) freely fastened on the pages. The book pages, however, can be of different shapes. As illustrated in FIG. 11 and FIG. 12, for example, the book page (3) can be a planar page from a nonwoven material with a thickness of 1 mm to 10 mm and its surface can be surface (3a) similarly made of a nonwoven material which provides a temporary rigid fastening by means of Velcro-type hook connections (5). Here, the hook-type connection provided on the lower side of the FIG. 5) provides the fastening onto the book page (3a). The upper side of the FIG. 5) can similarly be provided with a figure surface (5b) so that smaller FIG. 5c) can be positioned thereon as illustrated in FIG. 5 and FIG. 6. However, in order to provide a more rigid and stronger book page, the book pages (3) can comprise on at least one side, but preferably a two-layered page (3c) made of a nonwoven material, a book support (3b) provided in between said layered page (3c) by means of adhesion or sewing, and a page surface (3a) on the upper side, as illustrated in FIG. 13 and FIG. 14. Here the page support can be from cardboard, plastic material, composite material, or a normal thick textile material.

In order to avoid the book used in the education system according to the present invention from harming the children and not accumulate bacteria in/on itself, an anti-bacterial agent can be impregnated into the nonwoven material during the production or in the final step of the production of nonwoven materials. The impregnation can be implemented by means of spraying, dipping or similar methods.

### INDUSTRIAL APPLICABILITY

The education system according to the present invention and the book by which this system is implemented can be normally used for preschool children, as well as in any fields for spastic hindered persons, elder people etc. for rehabilitation purposes. The book can be designed in the form of a standard book rectangularly, or in a circular or triangular shape, or in the form of fruits, or in other shapes. It can also be designed in the form of a book with standard pages or with folded pages.

1. A book for implementing an education system, comprising at least two book pages, a page surface on the book page, wherein on the page surface soft intertwined nonwoven filaments are formed, and figures are positioned on the page surface by means of hook connectors.

2. The book according to claim 1, further comprising at least one book cover, wherein, the at least two book pages are provided between the book cover; at least one lace combining the book cover and the book pages.

3. The book according to claim 1, wherein the intertwined nonwoven filaments are provided with gaps left in between and the page surface is a surface with a nonwoven composition.

4. The book according to claim 1, wherein the hook connectors are provided on a lower side of the figures.

5. The book according to claim 1, further comprising second figures attached or fastened onto the figures and the each second figure comprises a nonwoven figure surface so that a second hook connectors are provided on the nonwoven figure surface for attaching the second figure onto the figures; wherein the second figures are smaller in size than the figures.

6. The book according to claim 4 further comprising a nonwoven figure surface on an upper side of the figures and second figures positioned on the nonwoven figure surface, wherein the second figures are smaller in size than the figures.

7. The book according to claim 1, wherein each book page is a two-layered page made of a nonwoven material, a book support is provided in between two layers of the two-layered page by means of adhesion or sewing, and the page support is made of a material selected from the group consisting of a cardboard, a plastic, a composite material, or a textile material.
